(19) United States
(12) Patent Application Publication
(10) Pub. No.: US 2011/0096255 A1
(43) Pub. Date: Apr. 28, 2011

(54) LIQUID CRYSTAL DISPLAY PANEL

(76) Inventors: Soon-Joon Rho, Suwon-shi (KR); Jae-Soo Jang, Suwon-si (KR); Sung-Jae Yun, Yongin-si (KR); Hyeok-Jin Lee, Seongnam-si (KR); Jae-Hong Park, Hwaseong-si (KR); Hong-Jo Park, Asan-si (KR); Sung-Hwan Hong, Suwon-si (KR); Oh-Jeong Kwon, Hwaseong-si (KR); Sung-Hwan Hong, Incheon (KR); Byung-Chul Kim, Incheon (KR); Hee-Seop Kim, Hwaseong-si (KR)

(21) Appl. No.: 12/836,020

(22) Filed: Jul. 14, 2010

(30) Foreign Application Priority Data
Oct. 28, 2009 (KR) 10-2009-0102984

(51) Int. Cl. C09K 19/02; G02F 1/133

(52) U.S. Cl. 349/33; 349/167

(57) ABSTRACT

A liquid crystal display that includes a first substrate, a second substrate facing the first substrate, liquid crystal disposed between the first substrate and the second substrate, wherein the liquid crystal is isotropic when no electric field is applied to the liquid crystal, and the liquid crystal is anisotropic when an electric field is applied to the liquid crystal, and an inner polarization layer formed on an inner surface of at least one of the first substrate and the second substrate.

### CROSS-REFERENCE TO RELATED APPLICATION

This application claims priority to Korean Patent Application No. 10-2009-0102984 filed in the Korean Intellectual Property Office on Oct. 28, 2009, the disclosure of which is incorporated by reference herein in its entirety.

### BACKGROUND OF THE INVENTION

1. Technical Field

The present invention relates to a liquid crystal display.

2. Discussion of the Related Art

As one of the widely used display panels, a liquid crystal display (LCD) includes two display panels provided with field generating electrodes such as pixel electrodes and a common electrode, and a liquid crystal (LC) layer interposed therebetween. The LCD displays images by applying voltages to the field generating electrodes to generate an electric field in the LC layer that determines the orientation of LC molecules therein to adjust polarization of incident light.

There is currently an emerging market for flexible display devices. A flexible LCD may be used to manufacture a flexible display device. However, when the flexible LCD is bent or pressure is applied to one of its substrates, the phase retardation value of the LC is changed due to a change in the cell gap of the flexible LCD. Further, the ability of a compensation film, which is attached to the outer surface of one of the substrates, to enhance color reproducibility and viewing angle, is deteriorated. Further, the flexible LCD includes a thick polarizer.

Accordingly, there is a need to improve the display characteristics and materials of a flexible LCD.

### SUMMARY OF THE INVENTION

A liquid crystal panel according to an exemplary embodiment of the present invention includes: a first substrate; a second substrate facing the first substrate; liquid crystal disposed between the first substrate and the second substrate, wherein the liquid crystal is isotropic when no electric field is applied to the liquid crystal, and the liquid crystal is anisotropic when an electric field is applied to the liquid crystal, and an inner polarization layer formed on an inner surface of at least one of the first substrate and the second substrate.

At least one of the first substrate and the second substrate may include a flexible plastic.

The inner polarization layer may be disposed on the inner surface of the first substrate, and a polarizer attached to the outer surface of the second substrate may be further included.

A color filter disposed on the inner surface of the second substrate may be further included.

A light blocking member disposed on the inner surface of the second substrate and disposed at a region where the color filter is not formed may be further included.

A spacer disposed on the inner surface of at least one of the first substrate and the second substrate may be further included.

The spacer may be disposed on the inner surface of the second substrate, and the spacer may include the same material as the light blocking member.

A seal member configured to enclose the liquid crystal between the first substrate and the second substrate, and including a material that is hardened by ultraviolet rays or a material that is hardened at a low temperature may be further included.

A pixel electrode and a common electrode may be disposed on the inner surface of the second substrate.

At least one of the pixel electrode and the common electrode may have at least one linear branch.

The common electrode may have a continuously planar structure in a region where the pixel electrode is formed.

The linear branch may be obliquely disposed with respect to a gate line or a data line of the second substrate.

The pixel electrode and the common electrode may each have at least one linear branch, and the linear branch of the pixel electrode and the linear branch of the common electrode may be parallel to each other.

The linear branch of the pixel electrode and the linear branch of the common electrode may be obliquely disposed with respect to a gate line and a data line of the second substrate.

The pixel electrode may have a first linear branch and a second linear branch that is not parallel to the first linear branch, and the common electrode may have a first linear branch and a second linear branch that is not parallel to the first linear branch of the common electrode.

The first linear branch and the second linear branch of the pixel electrode and the first linear branch and the second linear branch of the common electrode may be obliquely disposed with respect to a gate line and a data line.

The spacer may be disposed between the inner surface of the first substrate and the inner polarization layer.

A capping layer disposed on the color filter and the light blocking member may be further included.

A spacer disposed on the inner surface of at least one of the first substrate and the second substrate may be further included.

The spacer may be disposed between the inner surface of the first substrate and the inner polarization layer.

A liquid crystal panel according to an exemplary embodiment of the present invention includes: a first substrate, wherein the first substrate includes a pixel electrode, a common electrode, a color filter and a light blocking layer, a second substrate facing the first substrate, wherein the second substrate includes a polarization layer formed on a side of the second substrate facing the first substrate, and liquid crystal disposed between the first substrate and the second substrate, wherein the pixel electrode and common electrode control the liquid crystal with an electric field that is generated when a first voltage is applied to the pixel electrode and a second voltage is applied to the common electrode.

The polarization layer may include a thin liquid crystal layer.

The liquid crystal may include blue phase liquid crystal.

### BRIEF DESCRIPTION OF THE DRAWINGS

FIG. 1 is a layout view of a liquid crystal display according to an exemplary embodiment of the present invention;

FIG. 2 is a cross-sectional view taken along line II-II of FIG. 1;

FIG. 3 is a cross-sectional view of a liquid crystal display according to an exemplary embodiment of the present invention;

FIG. 4 is a cross-sectional view of a liquid crystal display according to an exemplary embodiment of the present invention;

FIG. 5 is a cross-sectional view of a liquid crystal display according to an exemplary embodiment of the present invention;

FIG. 6 is a cross-sectional view of a liquid crystal display according to an exemplary embodiment of the present invention;

FIG. 7 is a layout view of a liquid crystal display according to an exemplary embodiment of the present invention; and

FIG. 8 is a cross-sectional view of the liquid crystal display shown in FIG. 7 taken along line VIII-VIII.

### DETAILED DESCRIPTION OF EXEMPLARY EMBODIMENTS

Exemplary embodiments of the present invention will be described more fully hereinafter with reference to the accompanying drawings. However, the present invention may be embodied in various different ways and should not be construed as limited to the exemplary embodiments described herein.

In the drawings, the thickness of layers, films, panels, regions, etc., may be exaggerated for clarity. Like reference numerals may designate like elements throughout the specification and drawings. It will be understood that when an element such as a layer, film, region, or substrate is referred to as being “on” another element, it can be directly on the other element or intervening elements may also be present.

Hereinafter, exemplary embodiments of the present invention will be described using a liquid crystal panel as an example of a display panel. However, the present invention is not limited to the liquid crystal panel.

The liquid crystal panel according to the exemplary embodiments of the present invention may have the following characteristics.

Although the liquid crystal panel is bendable, a compensation film that can lessen the effect of a changed phase retardation value is not used. Rather, a liquid crystal (hereinafter referred to as “blue phase liquid crystal”) that is isotropic when no electric field is applied thereto and that is anisotropic when an electric field is applied thereto is used.

In addition, a common electrode and a pixel electrode are both formed on the same substrate, thereby enabling control of the blue phase liquid crystal with a lateral electric field. In addition, a color filter and a light blocking member are formed on the substrate including the common and pixel electrodes.

As a result, an upper substrate of the liquid crystal panel is formed with a polarizer and without the common electrode, the color filter, and the light blocking member. Further, the polarizer is not attached to the outer surface of the upper substrate but is formed of a material including a thin liquid crystal layer on the inner surface thereof. The polarizer is hereinafter referred to as an “inner polarization layer”. The upper substrate may be formed with a spacer as well as the inner polarization layer.

Next, a liquid crystal panel according to an exemplary embodiment of the present invention will be described with reference to the drawings.

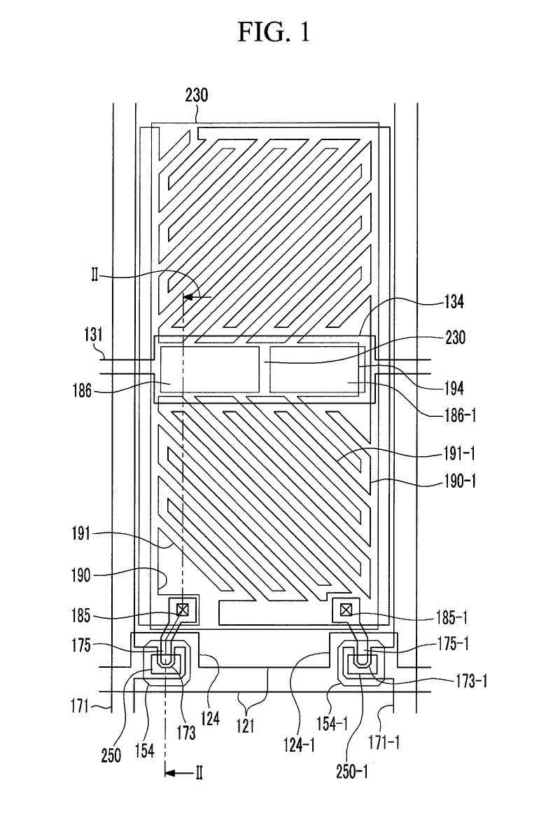

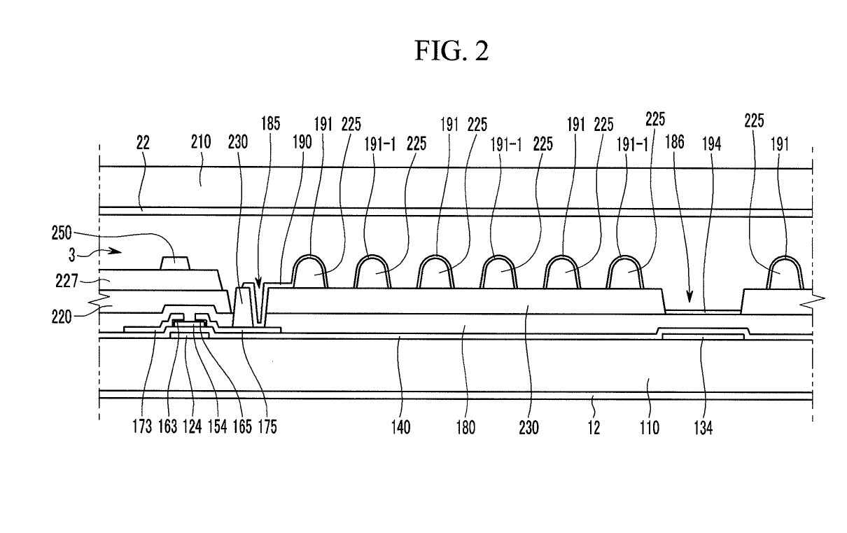

FIG. 1 is a layout view of a liquid crystal display according to an exemplary embodiment of the present invention, and FIG. 2 is a cross-sectional view taken along line II-II shown in FIG. 1.

First, a thin film transistor array panel is described.

Gate wires 121, 124, and 124-1 and a storage capacitance line 131 are formed on a transparent insulation substrate 110 that is made of glass or plastic, and so on.

The gate wires 121 and 124 include a gate line 121 that extends in a transverse direction, and a part of the gate line 121 protrudes upward to form gate electrodes 124 and 124-1. As shown in FIG. 1, two gate electrodes 124 and 124-1 are formed in each pixel area.

The storage capacitance line 131 is formed in parallel to the gate line 121 and has a wide width within a pixel area, thereby forming a storage electrode 134.

The gate wires 121, 124, and 124-1 and the storage capacitance line 131 are covered with a gate insulating layer 140, and semiconductor islands 154 and 154-1 that are made of amorphous silicon are formed on the gate insulating layer 140. The semiconductor islands 154 and 154-1 are overlapped with the gate electrodes 124 and 124-1 to form a channel of a thin film transistor. Ohmic contact islands 163, 165, 163-1, and 165-1 that are made of amorphous silicon in which an N-type impurity such as phosphorous is doped with a high concentration are formed on the semiconductor islands 154 and 154-1.

Data wires 171, 173, 175, 171-1, 173-1, and 175-1 are formed on the ohmic contact islands 163, 165, 163-1, and 165-1 and the gate insulating layer 140. Data wires 171, 173, 175, 171-1, 173-1, and 175-1 include two data lines 171 and 171-1 that extend in a vertical direction, source electrodes 173 and 173-1 that are respectively connected thereto, and drain electrodes 175 and 175-1 that are separated therefrom. The source electrodes 173 and 173-1 protrude from the data lines 171 and 171-1 in an upper part of the gate electrodes 124 and 124-1 and have a U shape or a horseshoe shape. The drain electrodes 175 and 175-1 are opposite to the source electrodes 173 and 173-1, and one end thereof is positioned within a U shape or a horseshoe shape of the source electrodes 173 and 173-1, and the other end thereof extends away from the U shape or the horseshoe shape of the source electrodes 173 and 173-1 and has a wide width.

The ohmic contact islands 163, 165, 163-1, and 165-1 are formed only in a region where the semiconductor islands 154 and 154-1 and the data wires 171, 173, 175, 171-1, 173-1, and 175-1 overlap. The gate electrode 124, the semiconductor island 154, the source electrode 173, and the drain electrode 175 become one transistor, and the gate electrode 124-1, the semiconductor island 154-1, the source electrode 173-1, and the drain electrode 175-1 that are symmetrically formed thereto become another transistor.

A passivation layer 180 is formed on the data wires 171, 173, 175, 171-1, 173-1, and 175-1. A color filter 230 and a black matrix member 220 (also referred to as “light blocking member 220”) are formed on the passivation layer 180. The black matrix member 220 is formed in an upper part of the transistor, the gate line 121, and the data lines 171 and 171-1. The color filter 230 is formed in a region where the black matrix member 220 is not formed, and contact holes 185, 185-1, 186 and 186-1 are formed in an upper part of the drain electrodes 175 and 175-1 and an upper part of the storage electrode 134. The contact holes 185 and 185-1 that are formed in an upper part of the drain electrode 175 and 175-1 are formed in the passivation layer 180 and the color filter 230, and expose the drain electrodes 175 and 175-1. In contrast, the contact holes 186 and 186-1 that are formed in an upper part of the storage electrode 134 are formed only in the color filter 230, and are not formed in the passivation layer 180.

A protrusion 225 is formed on the color filter 230, and a height control member 227 is formed on the light blocking member 220. In the present exemplary embodiment, the protrusion 225 has a bell-shaped cross-section, but may have various cross-sectional shapes such as a semicircular shape, a semi-oval shape, a triangular shape, and a trapezoidal shape. A side surface of the protrusion 225 has a tapered shape. Further, the height control member 227 is made of the same material as that of the protrusion 225, and has the same height as that of the protrusion 225. The height control member 227 is formed together with a spacer 250 that will be described later, thereby having a function for determining the height of the spacer 250.

First and second pixel electrodes 190 and 190-1 are formed on the protrusion 225. The first pixel electrode 190 and the second pixel electrode 190-1 are electrically connected to the drain electrodes 175 and 175-1 through the contact holes 185 and 185-1, respectively. The pixel electrodes 190 and 190-1 are formed with a transparent conductor such as indium tin oxide (ITO) or indium zinc oxide (IZO), and have a first linear electrode 191 and a second linear electrode 191-1 that extend in an oblique direction relative to the gate line 121 and the data lines 171 and 171-1. Further, both the first linear electrode 191 and the second linear electrode 191-1 in the first pixel electrode 190 and the second pixel electrode 190-1 are formed on the protrusion 225.

A structure of the first pixel electrode 190 is described as follows.

The first pixel electrode 190 has a trunk portion that is formed along the first data line 171, and a surface electrode 194 that corresponds to the storage electrode 134 and that is overlapped therewith and that is positioned at an upper part of the storage electrode 134. The first linear electrode 191 extends in an oblique direction from the trunk portion and the surface electrode 194, extends in a right upper direction in an upper region of the surface electrode 194, and extends in a right lower direction in a lower region of the surface electrode 194. The first linear electrode 191 is formed at an angle of about 45° relative to the gate line 121 or the data lines 171 and 171-1.

The second pixel electrode 190-1 has an upper portion and a lower portion in parallel to the gate line 121-1 and a side portion that is formed along the second data line 171-1, thereby having a trunk portion of an inverse [symbol] -shaped structure. The second linear electrode 191-1 extends from the trunk portion of an inverse [symbol] -shaped structure, extends in a left lower direction in an upper region of the surface electrode 194, and extends in a left upper direction in a lower region of the surface electrode 194.

The first linear electrode 191 and the second linear electrode 191-1 are formed on the protrusion 225, and are formed in parallel to each other. Different voltages are applied to the first linear electrode 191 and the second linear electrode 191-1. For example, a common voltage is applied to one of the first and second linear electrodes 191 and 191-1, and a data voltage is applied to the other of the first and second linear electrodes 191 and 191-1. Alternatively, a data voltage may be applied to one of the first and second linear electrodes 191 and 191-1, and a data voltage having an opposite polarity may be applied to the other of the first and second linear electrodes 191 and 191-1. The pixel electrode that is applied with the common voltage may be referred to as a common electrode. Here, a thin film transistor and a data line that are connected to the common electrode are omitted, and the common electrode may be applied with a common voltage through an additional common voltage application line (not shown).

On the other hand, the spacer 250 is formed on the height control member 227. The height of the spacer 250 is about the same as that of a cell gap, thereby forming a uniform cell gap between an upper insulation substrate 210 and the lower substrate 110. In addition, the spacer 250 may have a smaller height than the cell gap. For example, as shown in FIG. 2, the cell gap is supported by a liquid crystal layer 3, and the spacer 250 may only have enough height to maintain a minimum interval between the two substrates 110 and 210 when an external pressure is applied or one of the substrates 110 and 210 is bent.

A polarizer 12 is attached to the outside of the lower insulation substrate 110. The polarizer 12 may have a structure including polyvinyl alcohol (PVA) and tri-acetate cellulose (TAC), and may have a thickness of about 200 μm due to the thickness of the TAC. In this way, when the polarizer 12 has this thickness, the lower insulation substrate 110 may be a flexible substrate made of plastic; however, the lower insulation substrate 110 may support the polarizer 12 by using a substrate made of glass. For example, a flexible substrate made of plastic has a thickness of less than about 200 μm, and a substrate made of glass has a thickness of less than about 700 μm.

On the other hand, the upper panel only includes the inner polarization layer. This is because the light blocking member 220, the color filter 230, and so on are all formed in the thin film transistor array panel.

The upper insulation substrate 210 is made of plastic, thereby having a flexible characteristic. An inner polarization layer 22 is formed on the lower surface of the upper insulation substrate 210. The inner polarization layer 22 arranges the liquid crystal of a thin film liquid crystal film (TCF) in a predetermined direction such that only light having polarization of a predetermined direction can be transmitted. The inner polarization layer 22 includes the liquid crystal such that it is necessary that an alignment layer is formed between the upper insulation substrate 210 and the thin film liquid crystal film (TCF), or that an alignment characteristic is provided to the surface of the upper insulation substrate 210. To provide the alignment characteristic to the surface of the upper insulation substrate 210, the surface may be rubbed, or an ion beam or a plasma beam may be irradiated in a predetermined direction.

The inner polarization layer 22 is made of the liquid crystal material such that the polarization characteristic of the liquid crystal material may be broken when receiving a heat treatment of a high temperature. This is why the upper insulation substrate 210 formed with the inner polarization layer 22 may not include the additional layer.

The polarizer 12 and the inner polarization layer 22 of the thin film transistor array panel and the upper panel may be formed to have absorption axes representing the polarization directions of absorbed light to be perpendicular to each other, and the absorption axes may have an angle of about 45° relative to the first linear electrode 191 and the second linear electrode 191-1.

The alignment layer is not formed inside the thin film transistor array panel and the upper panel, and the liquid crystal layer 3 that is injected therebetween is the blue phase liquid crystal. The blue phase liquid crystal may have a cell gap of about 5 μm to about 15 μm, and has a larger cell gap than the liquid crystal of a twisted nematic (TN) mode and a vertical alignment (VA) mode liquid crystal display. The blue phase liquid crystal is disorderly arranged such that it has the isotropic characteristic when it has a cell gap of more than a predetermined value, and the blue phase liquid crystal is arranged in a predetermined direction with the application of an electric field, thereby inducing the crystal's phase retardation value. In other words, the blue phase liquid crystal is a liquid crystal that has an isotropic state when no electric field is applied thereto, and is changed to the anisotropic state when an electric field is applied thereto. Therefore, the blue phase liquid crystal has the characteristic that its phase retardation is not changed according to a change in the cell gap such that it is a liquid crystal material that is suitable for the flexible liquid crystal display. In addition, the blue phase liquid crystal has an optically isotropic characteristic such that, if the liquid crystal molecules of a predetermined portion thereof are only rotated by the electric field, the blue phase liquid crystal becomes optically anisotropic. Therefore, the response speed of the blue phase liquid crystal is fast.

Referring to FIG. 1 and FIG. 2, the exemplary embodiment of the present invention in which the inner polarization layer 22 is formed on the upper insulation substrate 210, the upper insulation substrate 210 has the flexible characteristic, the liquid crystal layer 3 uses the blue phase liquid crystal, the light blocking member 220, the first and second pixel electrodes 190 and 190-1, and the color filter 230 are formed on the lower insulation substrate 110, and the polarizer 12 is formed on the outer surface of the lower insulation substrate 110, was described.

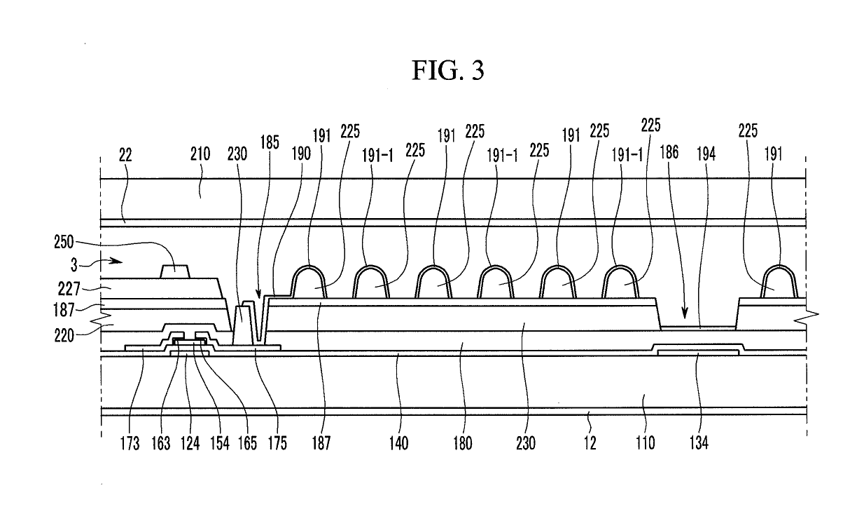

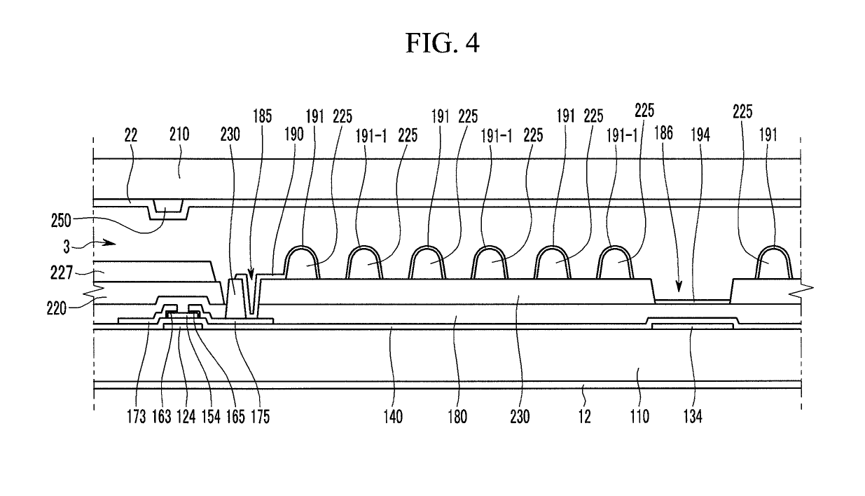

Next, variations of the cross-sectional structure of FIG. 2will be described with reference to FIG. 3 and FIG. 4.

FIG. 3 and FIG. 4 are cross-sectional views each showing a liquid crystal display according to an exemplary embodiment of the present invention.

First, in FIG. 3 that corresponds to FIG. 2, a capping layer 187 may be formed on the color filter 230 and the light blocking member 220.

The capping layer 187 may be made of the organic material or the inorganic material, provides a flat surface on the color filter 230 and the light blocking member 220, and makes the layered structure easy to form and arrange.

In the region where the capping layer 187 is formed on the color filter 230, the protrusion 225 and the first and second pixel electrodes 190 and 190-1 are formed, and in the region where the capping layer 187 is formed on the light blocking member 220, the height control member 227 and the spacer 250 are formed.

In FIG. 3, only the capping layer 187 is added compared with the exemplary embodiment of the present invention shown in FIG. 2; the other elements in FIG. 3 are the same as those in FIG. 2.

On the other hand, referring to FIG. 4 that corresponds to FIG. 2, a spacer 250 is formed inside the upper insulation substrate 210.

In other words, different from the exemplary embodiment of the present invention shown in FIG. 2, the spacer 250 (of FIG. 4) is formed inside the surface of the upper insulation substrate 210 at a position corresponding to the height control member 227. The spacer 250 may have a height corresponding to the cell gap, and may have a height that is less than the cell gap as shown in FIG. 4.

An inner polarization layer 22 is formed on the lower surface of the spacer 250 and the upper insulation substrate 210.

The inner polarization layer 22 is made of the liquid crystal material such that the polarization characteristic of the liquid crystal material may be broken when receiving a heat treatment of a high temperature. Accordingly, an additional layer may not be formed in the upper insulation substrate 210 that is formed with the inner polarization layer 22. However, since the spacer 250 is formed before forming the inner polarization layer 22, the polarization characteristic of the inner polarization layer 22 is not broken even though the inner polarization layer 22 is formed in the upper insulation substrate 210.

In the above description, the exemplary embodiment of the present invention further including the capping layer 187 and the exemplary embodiment of the present invention in which the spacer 250 is formed in the upper insulation substrate 210 were described referring to FIG. 3 and FIG. 4.

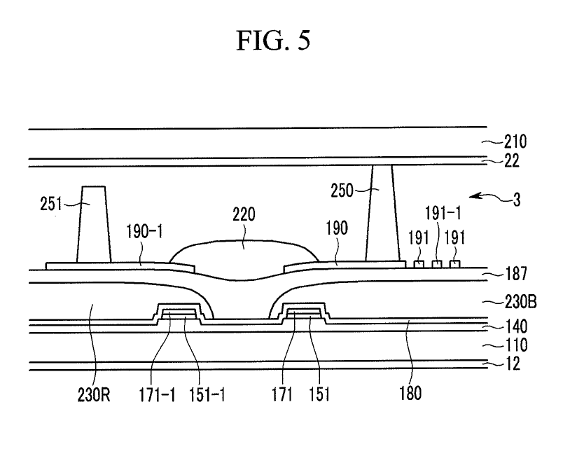

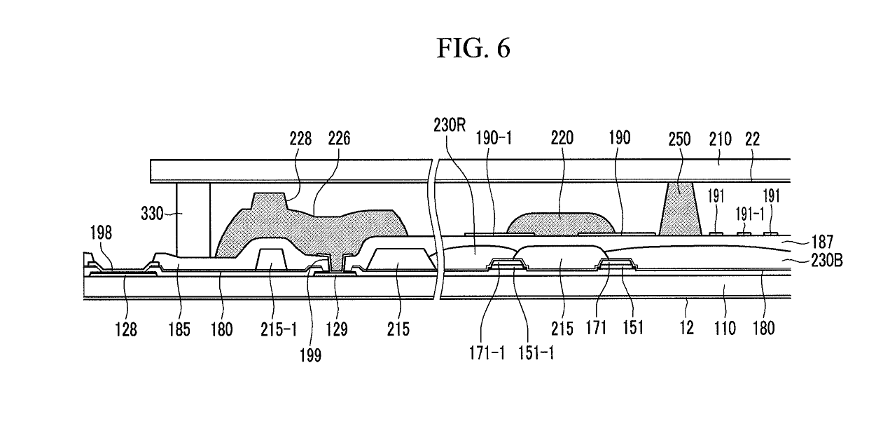

Next, exemplary embodiments of the present invention in which a spacer 250 is formed of the same material as the light blocking member 220 will be described with reference to FIG. 5 and FIG. 6.

FIG. 5 and FIG. 6 are cross-sectional views (focusing on data lines 171 and 171-1) each showing a liquid crystal display according to an exemplary embodiment of the present invention. The cross-sectional structures of FIG. 5 and FIG. 6 are different from that of FIG. 2 to FIG. 4; however, the structure of the gate line, the data line, the thin film transistor, and the pixel electrode of FIG. 5 and FIG. 6 may be the same as that of FIG. 2 to FIG. 4.

First, referring to FIG. 5, a thin film transistor array panel will be described.

A gate wire (not shown) and a storage capacitance line (not shown) are formed on an insulation substrate 110 made of a flexible material such as glass or plastic.

The gate wire includes a gate line extending in the transverse direction, and a portion of the gate line is extended or protruded thereby forming a gate electrode. As shown in FIG. 1, two gate electrodes are formed in each pixel area.

The storage capacitance line is parallel to the gate line, and a portion thereof is widened in the pixel area thereby forming a storage electrode.

The gate wire and the storage capacitance line are covered by a gate insulating layer 140, and semiconductor layers 151 and 151-1 made of amorphous silicon are formed on the gate insulating layer 140. The semiconductor layer (not shown) where a channel is formed among the semiconductor layer overlaps the gate electrode thereby forming the channel of the thin film transistor. On the other hand, the semiconductor layers 151 and 151-1 extend in the longitudinal direction like the data lines 171 and 171-1 at the position where the data lines 171 and 171-1 will be formed. The semiconductor layers 151 and 151-1 are formed under the data lines 171 and 171-1 because the semiconductor layers 151 and 151-1 and the data lines 171 and 171-1 are etched by the same mask. Ohmic contact layers (not shown) that are made of amorphous silicon in which an N-type impurity such as phosphorous is doped with a high concentration may be formed on the semiconductor layers 151 and 151-1.

Data wires 171 and 171-1 are formed on the semiconductor layers 151 and 151-1. The data wires 171 and 171-1 include two data lines 171 and 171-1 that extend in a vertical direction, source electrodes (not shown) that are respectively connected thereto, and drain electrodes (not shown) that are separated therefrom. The source electrodes may protrude from the data lines 171 and 171-1 in an upper part of the gate electrodes, and may have a U shape or a horseshoe shape. The drain electrodes are opposite to the source electrodes, and one end thereof is positioned within a U shape or a horseshoe shape of the source electrodes, and the other end thereof extends away from the U shape or the horseshoe shape of the source electrodes and has a wide width.

The ohmic contact layers are formed only in a region where the semiconductor layers 151 and 151-1 and the data wires 171 and 171-1 overlap.

A first gate electrode, the semiconductor layer on the first gate electrode, a first source electrode, and a first drain electrode form one transistor, and a second gate electrode, the semiconductor layer on the second gate electrode, a second source electrode, and a second drain electrode that are symmetrically formed thereto form another transistor.

A passivation layer 180 is formed on the data wires 171 and 171-1. A color filter 230 is formed on the passivation layer 180. The color filter 230 may include three color filters 230R, 230G, and 230B, and FIG. 5 shows two color filters 230R and 230B among them. The color filter 230 covers a pair of data lines 171 and 171-1. As shown in FIG. 5, the color filters 230R and 230B may not be overlapped with each other. However, according to an exemplary embodiment of the present invention, different from that shown in FIG. 5, the color filters 230R, 230G, and 230B may overlap each other, and if they overlap, they do not overlap the data line of the other side (e.g., in FIG. 5, the blue color filter 230B does not overlap the left data line 171-1, and the red color filter 230R does not overlap the right data line 171.

The color filter 230 is formed by depositing and etching a color filter dye.

A capping layer 187 is formed on the color filter 230. The capping layer 187 covers the rough surface due to the color filter 230 thereby planarizing the rough surface by more than a predetermined degree.

Pixel electrodes 190 and 190-1 are formed on the capping layer 187. The pixel electrodes 190 and 190-1 are formed with a transparent conductor such as ITO or IZO, and include a first linear electrode 191 and a second linear electrode 191-1 that extend in an oblique direction relative to the gate line 121 and the data lines 171 and 171-1. The first and second linear electrodes 191 and 191-1 are alternately arranged. The first and second linear electrodes 191 and 191-1 may have various structures that are different from those shown in FIG. 1.

Although not shown in FIG. 5, according to an exemplary embodiment of the present invention, the first and second linear electrodes 191 and 191-1 may be formed on a protrusion, like that shown in FIGS. 2 to 4. In addition, a height control member (not shown) made of the same material as the protrusion may be formed.

Spacers 250 and 251 are formed on the pixel electrodes 190 and 190-1, and a light blocking member 220 is formed in a region where images are not displayed between the data lines 171 and 171-1. In the present exemplary embodiment, the spacers 250 and 251 and the light blocking member 220 are formed with the same material, and are etched together. By controlling the light transmittance of a mask during etching, the spacers 250 and 251 and the light blocking member 220 having different heights may be formed. The light blocking member 220 and the spacers 250 and 251 may be made of a metal such as chromium, or a colored organic material including them both.

FIG. 5 shows the spacers 250 and 251 having different heights. In other words, one spacer 250 is contacted with the inner polarization layer 22 formed at the inside surface of the upper insulation substrate 210, and the other spacer 251 is separated from the inner polarization layer 22 by a predetermined distance.

The spacers 250 and 251 of FIG. 5 have heights corresponding to the cell gap, different from the exemplary embodiments of the present invention shown in FIG. 2 to FIG. 4.

Therefore, as shown in FIG. 2 to FIG. 5, the spacers may have various heights and may be selectively formed according to the exemplary embodiments of the present invention.

In the exemplary embodiments of the present invention shown in FIG. 2 to FIG. 4, the liquid crystal layer 3 has the function of maintaining the cell gap, and the spacer 250 maintains the cell gap of the predetermined value when the substrate is bent by external pressure; however, the two spacers 250 and 251 of FIG. 5 can maintain the cell gap by themselves, and thus the liquid crystal layer 3 functions as an extra aid for maintaining the cell gap.

A polarizer 12 is attached on the outer surface of the lower insulation substrate 110. The polarizer 12 may have a structure including polyvinyl alcohol (PVA) and tri-acetate cellulose (TAC). The lower insulation substrate 110 may be a flexible substrate such as plastic due to the thickness of the TAC; however, the polarizer 12 may be supported by using a substrate of glass.

On the other hand, in the upper panel, an upper insulation substrate 210 and an inner polarization layer 22 are formed.

The upper insulation substrate 210 is formed of plastic thereby having the flexible characteristic. The inner polarization layer 22 is formed on the lower surface of the upper insulation substrate 210. The inner polarization layer 22 arranges the liquid crystal of a thin film liquid crystal film (TCF in a predetermined direction so that light having polarization of only the predetermined direction is to be transmitted.

The inner polarization layer 22 is only formed in the upper panel. This is because the light blocking member 220 and the color filter 230 are both formed in the thin film transistor array panel, and the polarization characteristic of the inner polarization layer 22 is broken when the inner polarization layer 22 receives a heat treatment of a high temperature.

An alignment layer is not formed inside the thin film transistor array panel and the upper panel, and the injected liquid crystal layer 3 is the blue phase liquid crystal. The blue phase liquid crystal may have a cell gap of about 5 μm to about 15 μm, and has a larger cell gap than the liquid crystal of a TN mode and a VA mode liquid crystal display. The blue phase liquid crystal is disorderly arranged such that it has the isotropic characteristic when it has a predetermined cell gap, and the blue phase liquid crystal is arranged in a predetermined direction with the application of an electric field, thereby inducing the crystal's phase retardation value. Therefore, the blue phase liquid crystal has the characteristic that its phase retardation is not changed according to a change in the cell gap such that it is a liquid crystal material that is suitable for the flexible liquid crystal display.

An exemplary embodiment of the present invention in which the light blocking member 220 and the spacers 250 and 251 are formed with the same material in the thin film transistor array panel was described with reference to FIG. 5. In FIG. 5, the color filter 230 is formed by depositing and etching the dye.

Next, an exemplary embodiment of the present invention that involves forming the color filter 230 with an Inkjet method will be described with reference to FIG. 6. In FIG. 6, the light blocking member 220 and the spacer 250 are formed with the same material.

In addition, FIG. 6 also shows a seal region and a pad region as the outer portion of the liquid crystal panel.

First, a pixel area including the data lines 171 and 171-1 will be described with reference to FIG. 6.

The pixel area has a similar structure to that of FIG. 5. However, the color filter 230 is formed through the Inkjet method such that a partition 215 for enclosing the color filter 230 is formed outside the data lines 171 and 171-1 of the pixel area. The height of the partition 215 corresponds to the height of the color filter 230 that will be formed, and a process for forming the partition 215 is added compared with the process of FIG. 5. However, in the present exemplary embodiment, the etching process of FIG. 5 is not necessary when forming the color filter 230.

Now, the seal region and the pad region shown in the left side of FIG. 6 will be described.

A dummy pixel and a driving circuit (for example, a gate driving circuit) mounted on the lower insulation substrate 110 may be positioned at the outer part of the liquid crystal panel, and wiring for testing after manufacturing the liquid crystal panel may be formed. If necessary, the wiring may be extended into wiring of a different layer; however, when the wiring is extended without a disconnection, the wiring overlaps. This is shown by numerals of 129 and 199 of FIG. 6. In other words, the wiring referenced by the numeral 129 that is formed in the same layer as the gate line is exposed, and the wiring referenced by the numeral 199 that is formed in the same layer as the pixel electrode is connected thereto to transmit a signal.

In addition, the upper insulation substrate 210 and the lower insulation substrate 110 are attached and fixed, and a seal member 330 is formed to enclose the liquid crystal layer 3 formed therebetween.

The seal member 330 is formed between the capping layer 187 of the lower insulation substrate 110 or the upper portion of the passivation layer 180 according to the present exemplary embodiment, and the inner polarization layer 22 of the upper insulation substrate 210. The seal member 330 is hardened after forming it between the two insulation substrates 110 and 210, but by executing the heat hardening at a high temperature, the polarization characteristic of the inner polarization layer 22 may be deteriorated. Therefore, the seal member 330 is made of a material that is hardened by only ultraviolet rays or a material that is capable of hardening at a low temperature.

Pads 128 and 198 that receive external signals are formed outside the seal member 330. The pad portion may include a portion 128 that is extended from the corresponding wiring and a portion 198 to improve a contact characteristic.

A dummy partition 215-1 made of the same material as the partition 215 may be further formed at the circumference of the liquid crystal panel. An outer light blocking member 226 made of the same material as the light blocking member 220 is formed on the dummy partition 215-1. The outer light blocking member 226 may have a different height from the light blocking member 220 of the display area, and as shown in FIG. 6, the outer light blocking member 226 may have at least two different heights. The portion that has the highest height may function as an outer spacer 228 supporting the interval between the upper and lower substrates 210 and 110 at the outer portion. The dummy partition 215-1 is formed at a position corresponding to the outer spacer 228 thereby being the structure that is additionally formed to increase the height of the outer spacer 228.

In the exemplary embodiment of the present invention shown in FIG. 6, the light blocking member 220, the spacer 250, the outer light blocking member 226, and the outer spacer 228 are formed with the same material, and may be simultaneously etched by controlling the light transmittance of the etch mask used in the same process.

The outer portion of the panel shown in the left side of FIG. 6 is just one example thereof, and it may further include various elements.

The exemplary embodiments of the present invention in which the light blocking member 220 and the spacer 250 are formed with the same material were described with reference to FIG. 5 and FIG. 6.

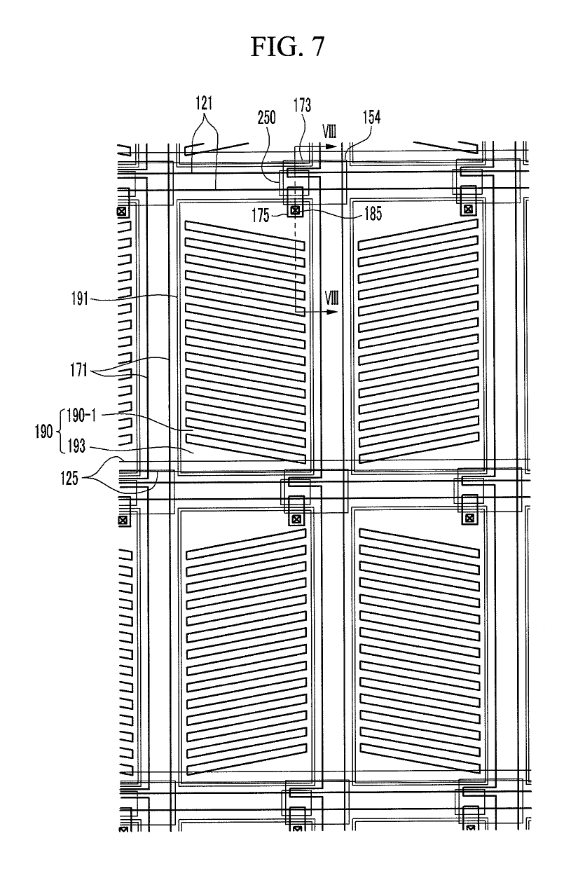

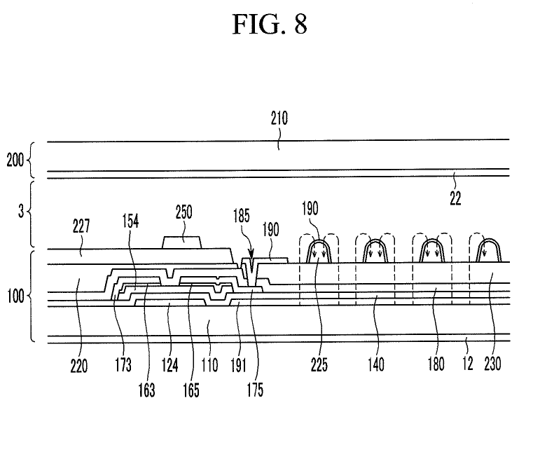

Next, an exemplary embodiment of the present invention in which one electrode has a linear electrode structure and the other electrode has a plane structure for applying the lateral electric field to the blue phase liquid crystal will be described with reference to FIG. 7 and FIG. 8.

FIG. 7 is a layout view of a liquid crystal display according to an exemplary embodiment of the present invention, and FIG. 8 is a cross-sectional view of the liquid crystal display shown in FIG. 7 taken along line VIII-VIII.

A lower panel 100 will now be described.

A plurality of gate lines 121 and a plurality of common electrode lines 125 are formed on a transparent insulation substrate 110 that is made of glass or plastic, and so on.

The gate lines 121 transmit gate signals, and extend in the transverse direction. Each gate line 121 includes a plurality of gate electrodes 124 and an end portion (not shown) having a large area for connection with another layer or an external driving circuit.

The common electrode lines 125 transmit the common voltage, and are parallel to the gate lines 121 in the transverse direction. The common electrode lines 125 are made of the same layer as the gate lines 121, are positioned between two neighboring gate lines 121, and may have an expansion (not shown) protruding upward and downward to prevent light leakage.

A plurality of common electrodes 191 are formed on the substrate 110 and the common electrode lines 125. The common electrode 191 is commonly connected to the common electrode lines 125 thereby receiving the common voltage from the common electrode lines 125. The common electrode 191 has a rectangular shape and is arranged as a matrix, and almost fills the space between the gate lines 121 thereby having a plane structure.

The common electrode 191 may be made of the transparent conductive material such as indium tin oxide (ITO) or indium zinc oxide (IZO).

A gate insulating layer 140 made of silicon nitride (SiNx) or silicon oxide (SiOx) is formed on the gate lines 121, the common electrode lines 125, and the common electrode 191.

A plurality of semiconductor islands 154 that are made of hydrogenated amorphous silicon (a-Si is an abbreviation for amorphous silicon), polysilicon, or so on are formed on the gate insulating layer 140. The semiconductor islands 154 are positioned on the gate electrodes 124.

A plurality of ohmic contact islands 163 and 165 are formed on the semiconductor islands 154. The ohmic contact islands 163 and 165 may be made of n+ hydrogenated amorphous silicon in which n-type impurities, such as phosphorus, are doped with a high concentration, or of a silicide. The ohmic contact islands 163 and 165 are disposed as pairs on the semiconductor islands 154.

A plurality of data lines 171 and a plurality of drain electrodes 175 are formed on the ohmic contact islands 163 and 165 and the gate insulating layer 140.

The data lines 171 transfer data signals and mainly extend in a transverse direction, thereby intersecting the gate lines 121. Each data line 171 includes a plurality of source electrodes 173 extending toward the gate electrodes 124 and an end portion (not shown) with a wide area for connection with a different layer or an external driving circuit.

The drain electrodes 175 are separated from the data lines 171 and face the source electrodes 173 with respect to the gate electrodes 124.

The ohmic contact islands 163 and 165 exist only between the underlying semiconductor islands 154 and the overlying data lines 171 and drain electrodes 175 to lower a contact resistance therebetween.

One gate electrode 124, one source electrode 173, and one drain electrode 175 constitute a thin film transistor together with the semiconductor island 154, and a channel of the thin film transistor is formed at the semiconductor island 154 between the source electrode 173 and the drain electrode 175.

A passivation layer 180 is formed on the data line 171, the drain electrode 175, and the exposed portions of the semiconductor island 154. The passivation layer 180 is made of an inorganic insulator, and the inorganic insulator includes, for example, silicon nitride and silicon oxide. However, the passivation layer 180 can have a dual-layer structure of a lower inorganic layer and an upper organic layer to prevent damage to the exposed portions of the semiconductor island 154 while having excellent insulating characteristics of the organic layer.

A color filter 230 and a light blocking member 220 are formed on the passivation layer 180. The color filter 230 is disposed at a region for displaying images, and the light blocking member 220 is formed at a position corresponding to the gate lines 121, the data lines 171, and the thin film transistor.

The color filter 230 and the passivation layer 180 have a plurality of contact holes 185 exposing the drain electrodes 175.

A protrusion 225 is formed on the color filter 230, and a plurality of pixel electrodes 190, particularly a linear electrode 190-1 of the pixel electrode 190, is formed on the protrusion 225. They may be made of a transparent conductive material such as indium tin oxide (ITO) or indium zinc oxide (IZO).

The pixel electrode 190 includes a plurality of linear electrodes 190-1 overlapping the common electrode 191 and arranged parallel to each other, and a connection 193 commonly connecting them.

The linear electrodes 190-1 are inclined at a predetermined angle with respect to the gate line 121 or the horizontal direction. The connection 193 includes a longitudinal connection connecting both ends of the plurality of linear electrodes 190-1 and a transverse connection disposed at the upper and lower portions of the linear electrodes 190-1.

The outer boundary of the connection 193 defining the boundary of the pixel electrode 190 has a rectangular shape.

If the data voltage is applied to the pixel electrode 190 and the common voltage is applied to the common electrode 191, an electric field is formed by the potential difference between the two voltages. Electric field lines are represented by the dotted lines of FIG. 8.

On the other hand, a height control member 227 is formed on the light blocking member 220. The height control member 227 is formed with the same material as the protrusion 225, and has a height corresponding to the height of the protrusion 225.

A spacer 250 is formed on the height control member 227. The spacer 250 functions to maintain the interval between an upper insulation substrate 210 and the lower insulation substrate 110 along with the height control member 227.

On the other hand, a polarizer 12 is attached to the outer surface of the lower insulation substrate 110.

Next, an upper panel 200 will be described.

An inner polarization layer 22 is formed on the inner surface of the insulation substrate 210 made of the transparent plastic. The inner polarization layer 22 arranges the liquid crystal of a thin film liquid crystal film (TCF) in a predetermined direction so that only light having polarization of a predetermined direction is to be transmitted. The inner polarization layer 22 includes the liquid crystal such that it is necessary for an alignment layer to be formed between the upper insulation substrate 210 and the thin film liquid crystal film (TCF), or for an alignment characteristic to be provided to the surface of the upper insulation substrate 210. To provide the alignment characteristic to the surface of the upper insulation substrate 210, the surface may be rubbed, or an ion beam or a plasma beam may be irradiated in a predetermined direction.

The inner polarization layer 22 is made of the liquid crystal material such that the polarization characteristic of the liquid crystal material may be broken when receiving a heat treatment of a high temperature. This is because the upper insulation substrate 210 that is formed with the inner polarization layer 22 may not include the additional layer.

The alignment layer is not formed inside the thin film transistor array panel and the upper panel, and the liquid crystal layer 3 that is injected therebetween is the blue phase liquid crystal. The blue phase liquid crystal may have a cell gap of about 5 μm to about 15 μm, and has a larger cell gap than the liquid crystal of a TN mode and a VA mode liquid crystal display. The blue phase liquid crystal is disorderly arranged such that it has an isotropic characteristic when it has a cell gap of more than a predetermined value, and the blue phase liquid crystal is arranged in the predetermined direction with the application of an electric field, thereby inducing the crystal's phase retardation value. In other words, the blue phase liquid crystal is a liquid crystal that has an isotropic state when no electric field is applied thereto, and is changed to the anisotropic state when an electric field is applied thereto. Therefore, the blue phase liquid crystal has the characteristic that its phase retardation is not changed according to a change in the cell gap such that it is a liquid crystal material that is suitable for the flexible liquid crystal display. On the other hand, the blue phase liquid crystal has an optically isotropic characteristic such that, if the liquid crystal molecules of a predetermined portion thereof are only rotated by the electric field, the blue phase liquid crystal becomes optically anisotropic. Therefore, the response speed of the blue phase liquid crystal is fast.

The exemplary embodiment of the present invention in which the blue phase liquid crystal is controlled by the plane common electrode and the linear pixel electrode was described with reference to FIG. 7 and FIG. 8.

In a liquid crystal display according to an exemplary embodiment of the present invention, a blue phase liquid crystal is used. Thus, even if the substrate made of plastic is bent, it is not necessary to use a compensation film since the blue phase liquid crystal's ability to maintain its phase retardation value in view of a changing cell gap prevents the display characteristics of the liquid crystal display from being deteriorated. In addition, even if external pressure is applied to the liquid crystal display, the display characteristics of the liquid crystal display are not deteriorated. Further, the liquid crystal display may be made thin since it uses an inner polarization layer instead of a polarizer including PVA or TAC.

While the present invention has been described in detail with reference to the exemplary embodiments, those skilled in the art will appreciate that various modifications and substitutions can be made thereto without departing from the spirit and scope of the present invention as set forth in the appended claims.

What is claimed is:

1. A liquid crystal panel, comprising:
a first substrate;
a second substrate facing the first substrate;
liquid crystal disposed between the first substrate and the second substrate, wherein the liquid crystal is isotropic when no electric field is applied to the liquid crystal, and the liquid crystal is anisotropic when an electric field is applied to the liquid crystal; and
an inner polarization layer disposed on an inner surface of at least one of the first substrate and the second substrate.

2. The liquid crystal panel of claim 1, wherein at least one of the first substrate and the second substrate comprises a flexible plastic.

3. The liquid crystal panel of claim 2, wherein the inner polarization layer is disposed on the inner surface of the first substrate, and
the liquid crystal panel further comprises a polarizer attached to an outer surface of the second substrate.

4. The liquid crystal panel of claim 3, further comprising a color filter disposed on the inner surface of the second substrate.

5. The liquid crystal panel of claim 4, further comprising a light blocking member disposed on the inner surface of the second substrate, and disposed at a region where the color filter is not formed.

6. The liquid crystal panel of claim 5, further comprising a spacer disposed on the inner surface of at least one of the first substrate and the second substrate.

7. The liquid crystal panel of claim 6, wherein the spacer is disposed on the inner surface of the second substrate, and the spacer comprises the same material as the light blocking member.

8. The liquid crystal panel of claim 7, further comprising a seal member configured to enclose the liquid crystal between the first substrate and the second substrate, and including a material that is hardened by ultraviolet rays or a material that is hardened at a low temperature.

9. The liquid crystal panel of claim 8, wherein a pixel electrode and a common electrode are disposed on the inner surface of the second substrate.

10. The liquid crystal panel of claim 9, wherein at least one of the pixel electrode and the common electrode has at least one linear branch.

11. The liquid crystal panel of claim 10, wherein the common electrode has a continuously planar structure in a region where the pixel electrode is disposed.

12. The liquid crystal panel of claim 11, wherein the linear branch is obliquely disposed with respect to a gate line or a data line.

13. The liquid crystal panel of claim 10, wherein the pixel electrode and the common electrode each have at least one linear branch, and the linear branch of the pixel electrode and the linear branch of the common electrode are parallel to each other.

14. The liquid crystal panel of claim 13, wherein the linear branch of the pixel electrode and the linear branch of the common electrode are obliquely disposed with respect to a gate line or a data line of the second substrate.

15. The liquid crystal panel of claim 13, wherein the pixel electrode has a first linear branch and a second linear branch that is not parallel to the first linear branch, and the common electrode has a first linear branch and a second linear branch that is not parallel to the first linear branch of the common electrode.

16. The liquid crystal panel of claim 15, wherein the first linear branch and the second linear branch of the pixel electrode and the first linear branch and the second linear branch of the common electrode are obliquely disposed with respect to a gate line or a data line of the second substrate.

17. The liquid crystal panel of claim 6, wherein the spacer is disposed between the inner surface of the first substrate and the inner polarization layer.

18. The liquid crystal panel of claim 5, further comprising a capping layer disposed on the color filter and the light blocking member.

19. The liquid crystal panel of claim 18, further comprising a spacer disposed on the inner surface of at least one of the first substrate and the second substrate.

20. The liquid crystal panel of claim 19, wherein the spacer is disposed between the inner surface of the first substrate and the inner polarization layer.

21. A liquid crystal panel, comprising:
a first substrate, wherein the first substrate includes a pixel electrode, a common electrode, a color filter and a light blocking layer;
a second substrate facing the first substrate, wherein the second substrate includes a polarization layer formed on a side of the second substrate facing the first substrate; and
liquid crystal disposed between the first substrate and the second substrate, wherein the pixel electrode and common electrode control the liquid crystal with an electric field that is generated when a first voltage is applied to the pixel electrode and a second voltage is applied to the common electrode.

22. The liquid crystal panel of claim 21, wherein the polarization layer includes a thin liquid crystal layer.

23. The liquid crystal panel of claim 21, wherein the liquid crystal includes blue phase liquid crystal.
